(19) United States
(12) Patent Application Publication
(10) Pub. No.: US 2006/0250216 A1
(43) Pub. Date: Nov. 9, 2006

(54) Portable electronic data acquisition and transmission system

(76) Inventor: Richard E. Gagnon, Pensacola, FL (US)

Correspondence Address: RENNER, KENNER, GREIVE, BOBAK, TAYLOR & WEBER, FIRST NATIONAL TOWER FOURTH FLOOR, 106 S. MAIN STREET, AKRON, OH, 44308, US

(21) Appl. No.: 11/123,347

(22) Filed: May 6, 2005

(51) Int. Cl. B60R 25/00; G05B 19/00

(52) U.S. Cl. 340/5.71; 340/5.25

(57) ABSTRACT

A portable electronic data acquisition and transmission system for use with a plurality of wireless transmitters and universal operators used with selected residential barrier operators includes a data monitor having a monitor controller connected to a monitor receiver, a display, a monitor memory unit, a monitor communications port, and an input interface. The data monitor is able to learn and store a plurality of transmitter identification codes associated with one or more wireless transmitters. Once the identification codes are stored in the data monitor, the identification codes can be manipulated and transferred to one or more universal operators, thus enabling the specific transmitters having the associated identification codes to control the universal operator.

### TECHNICAL FIELD

The present invention relates to an electronic data acquisition and transmission system for receiving, storing, manipulating, and transferring electronic identification codes associated with wireless barrier operator transmitters. More specifically, the present invention is directed to an electronic data acquisition and transmission system that is portable. Particularly, the present invention pertains to an electronic data acquisition and transmission system that provides a user-friendly visual interface to allow a user to interact and manipulate transmitter identification codes.

### BACKGROUND

Typically, gated communities or the like provide an access barrier, such as a gate, to permit entry only to the members of such communities. These access gates are generally moved between open and closed positions by a barrier operator that is actuated via a pre-selected wireless transmitter. Because of the number of members that live within such communities, it is required that the unique identification codes or data associated with each of the numerous transmitters be “learned” to the “community” or universal barrier operator. This ensures that only those transmitters issued to community members are able to actuate the community access barrier, or gate. These transmitters are usually provided with multiple transmission buttons, wherein a primary button is associated with the community or universal operator and secondary buttons are learned to operators used with individual residences. As such, the task of “learning” a number of transmitters to a barrier operator can become time consuming, and cumbersome, especially if there are an appreciable number of transmitters that need to actuate a particular access barrier. The problem is further compounded if there are a number of access barriers associated with a gated community that must also be learned with a member's wireless transmitter.

Typically, to “learn” a transmitter with a barrier operator, one must perform a sequence of steps that involve depressing several buttons on the wireless transmitter in a predetermined sequence and/or the barrier operator. Thus, if the user makes a mistake during the learning sequence, the entire sequence must be restarted. Additionally, during the learning process, the user must be relatively close to the receiver of the barrier operator to allow for proper signal reception. Thus, in the case of a gated community, where the access gate and barrier operator are located outdoors, a user may have to endure inclement weather until he or she has completed the learning sequence for each transmitter that is being learned to actuate the access barrier. And, the learning codes or transmitter identification codes uniquely associated with a transmitter are transmitted to the barrier operator's receiver via radio frequency (RF) signals. Periodically, the signals transmitted between the transmitter and operator as part of the learning sequence may be compromised due to errors caused by local noise or interference. As a result, it may take the user several attempts to successfully learn the transmitter with the receiver under such conditions.

Therefore, there is a need for an electronic data acquisition and transmission system that is able to store a plurality of transmitter identification codes that are associated with a barrier operator's wireless transmitter. Additionally, there is a need for an electronic data acquisition and transmission system that is user friendly, and allows a user to receive, store, manipulate, and transfer transmitter identification codes of a plurality of wireless transmitters, which are used to actuate an access barrier between open and closed positions. Furthermore, there is a need for an electronic data acquisition and transmission system that is able to receive and transfer transmitter identification codes to a barrier operator's receiver via a data port, such as a serial interface that is less susceptible to interference errors. In addition, there is a need for an electronic data acquisition and transmission system that is portable allowing the system to transfer stored transmitter identification codes to a plurality of operators.

### DISCLOSURE OF INVENTION

In light of the foregoing, it is a first aspect of the present invention to provide a portable electronic data acquisition and transmission system.

It is another aspect of the present invention to provide an electronic data acquisition and transmission system for processing transmitter identification codes used with a universal barrier operator, the system comprising a monitor controller configured to receive and store transmitter identification codes, wherein selected transmitter identification codes enable operation of selected barrier operators, and wherein all the transmitter identification codes enable operation of the universal barrier operator, and an input interface coupled to the monitor controller, the input interface providing functional options to process the transmitter identification codes.

Yet another aspect of the present invention is a method of learning one or more transmitter identification codes that enable operation of selected barrier operators, wherein all of the transmitter identification codes enable operation of a universal operator, the method comprising providing a data monitor having a monitor controller connected to an input interface, providing at least one transmitter having at least one identification code that enables operation of a selected barrier operator, and where all the identification codes enable operation of a universal barrier operator, enabling a learn mode of the monitor controller through the input interface, and transmitting the at least one identification code from the at least one transmitter for receipt by the data monitor during the learn mode.

Still another aspect of the present invention is a method of exchanging one or more transmitter identification codes that enable operation of selected barrier operators to a universal barrier operator, comprising providing a data monitor having a monitor controller connected to an input interface, providing a monitor memory unit connected to the monitor controller, the monitor memory unit adapted to store at least one transmitter identification code that enables operation of at least one selected barrier operator, providing a universal barrier operator having a universal barrier operator controller and a universal operator memory module adapted to store all the transmitter identification codes which enable operation of the universal barrier operator, coupling the data monitor to a universal barrier operator, enabling a transfer mode of the monitor controller through the input interface, and exchanging the transmitter identification codes between the monitor memory unit and the universal operator memory module during the transfer mode.

### DESCRIPTION OF THE DRAWINGS

These and other features and advantages of the present invention will become better understood with regard to the following description, appended claims, and accompanying drawings wherein:

FIG. 1 is a block diagram of a living or gated community with a universal operator for controlling access to the community, each housing unit of the community contains a barrier operator as shown in the schematic view inset, the universal operator having a connected data monitor made in accordance with the concepts of the present invention;

FIG. 2 is a block diagram of the universal operator coupled to the data monitor via a communications link;

FIG. 3 is a schematic diagram of the data monitor of the electronic data acquisition and transmission system made in accordance with the concepts of the present invention that includes a plurality of buttons that comprise an input interface;

FIGS. 4A-C comprise a schematic diagram of the data monitor of the present system; and

FIGS. 5A-D comprise a state diagram showing the operational steps provided by the data monitor during operation, and in response to inputs made by a user via the input interface.

### BEST MODE FOR CARRYING OUT THE INVENTION

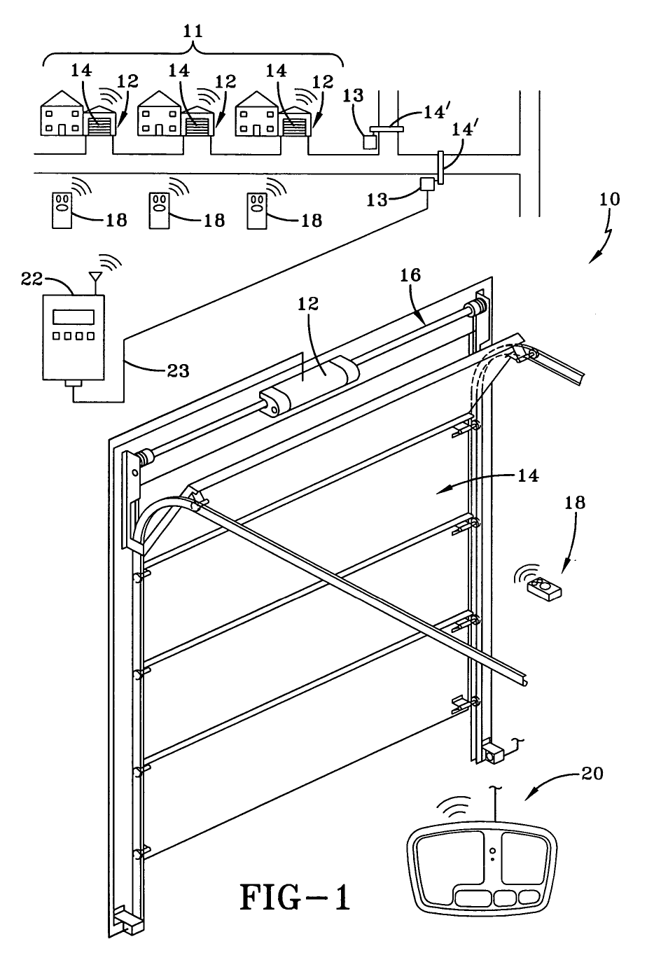

A system for receiving, storing, manipulating, and transferring electronic identification codes for a wireless transmitter is generally designated by the numeral 10, as shown in FIG. 1 of the drawings. While the present system 10 shown in FIG. 1 is configured for use with a gated community 11, the present system 10 may be easily adapted for use in other arrangements where it is necessary to transfer transmitter identification codes to one or more barrier operators 12 or to one or more universal barrier operators 13. The present system 10 comprises one or more barrier operators 12, one or more universal barrier operators 13, a residential access barrier or door 14, a universal access barrier or gate 14′, a linkage 16, one or more wireless transmitters 18, one or more wireless wall stations 20, a data monitor 22, and a communications link 23. Specifically, FIG. 1 shows a number of housing units within the community 11 each with an installed barrier operator 12 and a residential access barrier 14 such as a garage door, as shown more precisely in the inset of the Figure. Access to the community 11 is limited by an access barrier, such as a universal gate 14′ that is actuated by a universal operator 13 via the appropriate linkage. Each of the installed barrier operators 12 are activated by a pre-selected wireless transmitter 18 and/or wall station transmitter 20. The transmitters may also be in the form of a keypad or keyless entry transmitter. The wireless transmitter 18 and wireless wall station 20 use unique identification codes that are learned to a barrier operator 12 or universal operator 13 such that only pre-selected transmitters 18 or wall stations 20 can actuate a specific barrier operator 12 or universal operator 13. That is, the unique identification codes allow the barrier operator 12 or universal operator 13 to discriminate between the learned and non-learned transmitters 18 or wall stations 20 in the vicinity, which may be transmitting signals. Once learned with the desired barrier 12 or universal barrier operator 13, the wireless transmitter 18 or wall station 20 can control certain functions provided by the barrier operator 12 or universal operator 13, such as moving the garage door 14 or access gate 14′ between open and closed positions. It will be appreciated that the transmitter identification codes may be in any format commonly used with barrier operators such as fixed codes, hopping codes or any encrypted type transmission code format. Movement of the door 14 or gate 14′ may also be initiated by a wired control signal.

However, when it is necessary to learn the identification codes of numerous transmitters 18 or wall stations 20 with several universal operators 13, a data monitor 22 may be utilized to facilitate the learning process. For example, if numerous transmitters and stations 18,20 are in use within the community 11 to actuate the barrier operators 12 provided, then the data monitor 22 can be utilized to aggregate all of the transmitter identification codes. Once aggregated in the data monitor 22, the codes can be transferred to one or more universal operators 13 in bulk, thereby saving the user the time and effort of individually learning each transmitter 18 or station 20 with each universal operator 13. Specifically, the data monitor 22 allows a user to at least receive, view, store, delete, and transfer the unique transmitter identification codes relating to the one or more of the transmitters 18 and wall stations 20. After the identification codes of a number of transmitters or stations 18,20 are learned with the data monitor 22, the user may transfer the stored transmitter identification data to a universal barrier operator 13 that is capable of interfacing with the data monitor 22 via the communications link 23. Once the transmitter identification codes have been transferred, each of the wireless transmitters 18 or wall stations 20 may be used to actuate the universal operator 13 so as to move the gate 14′ in a manner to gain entry to the gated community 11. In addition, the data monitor 22 is also able to acquire any transmitter identification codes stored at the universal operator. Once the codes are acquired, the monitor 22 can transfer the identification codes to other universal operators 13. Furthermore, the data monitor 22 also allows the user to manipulate and transfer the learned transmitter identification data in a variety of ways to be discussed later.

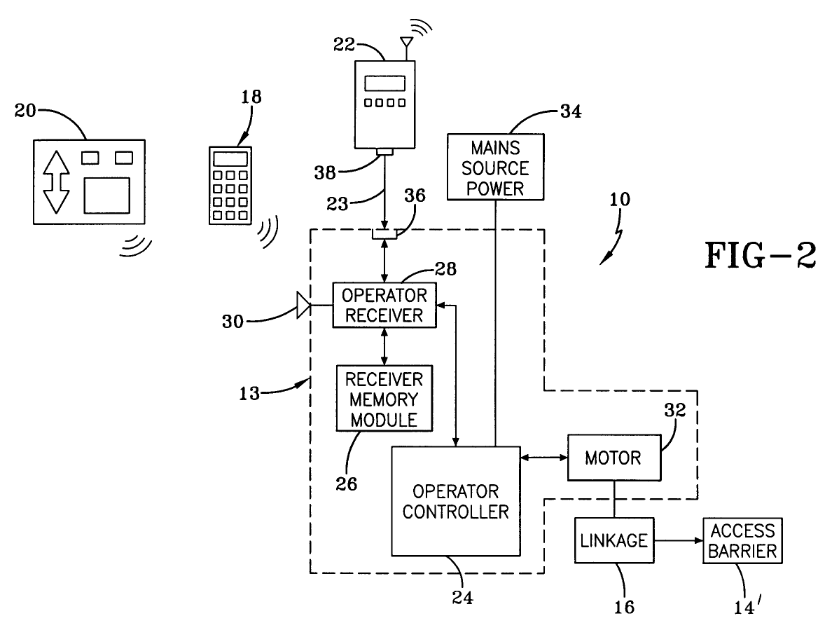

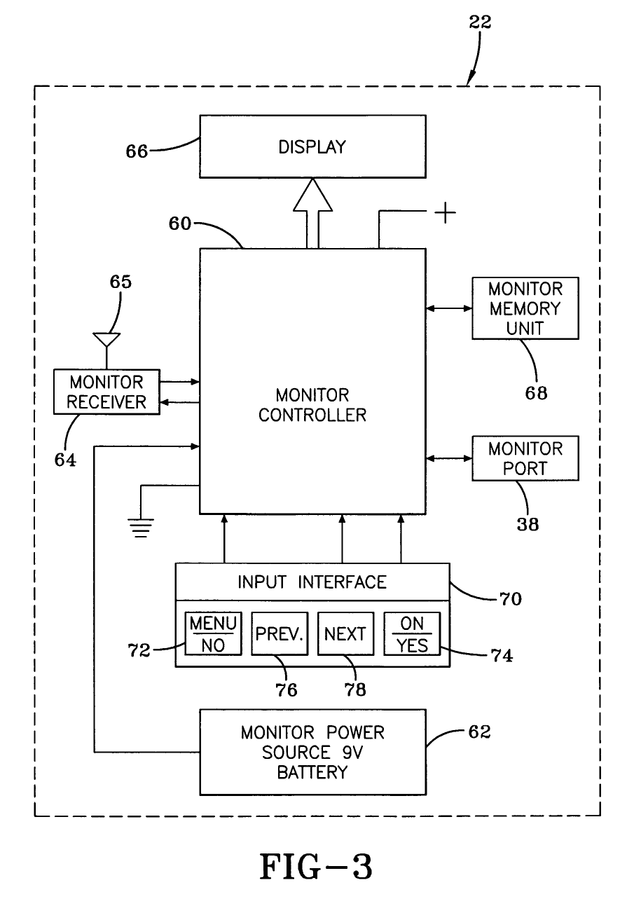

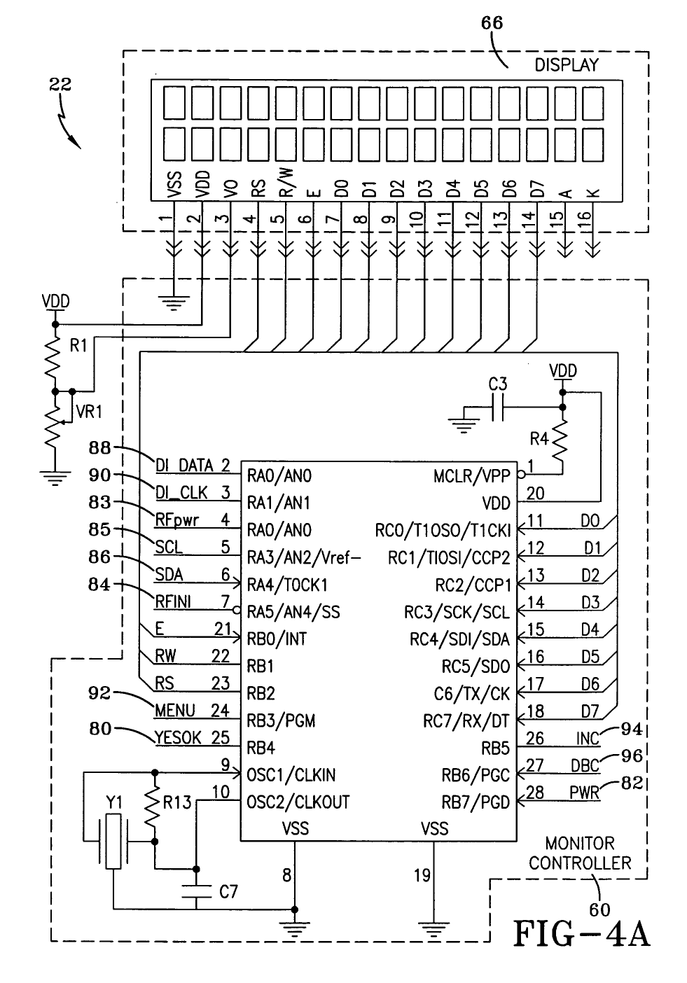

FIG. 2 shows the universal operator 13 of the present system 10 comprising an operator controller 24, a receiver memory module 26, an operator receiver 28, an operator antenna 30, a motor 32, a mains power source 34, and an operator port 36. The operator controller 24 includes a logic control that may be implemented using a general purpose, or application specific semiconductor based microprocessor/microcontroller that provides the necessary hardware and software to carry out the functions to be described. Coupled to the operator controller 24 is the operator receiver 28 which will be discussed later. Also coupled to the operator receiver 28 is a receiver memory module 26 which provides the operator receiver 28 with the necessary storage to allow the operator controller 24 to store and retrieve the data required for the operator controller 24 and operator receiver 28 to function in the desired manner. Specifically, the memory module 26 may be used to store transmitter identification codes relating to one or more wireless transmitters 18 or wireless wall stations 20, which have been transferred to it from the data monitor 22. In addition, the receiver memory module 26 may store transmitter identification codes for transmitters that have been individually learned with the universal operator 13. It should be appreciated that the memory module 26 may be comprised of any suitable non-volatile memory, such as an EEPROM (electronically erasable programmable read-only memory), or other suitable memory.

Specifically, the operator receiver 28 includes an operator antenna 30 that allows the operator receiver 28 to detect signals transmitted to the universal operator 13 by the wireless transmitter 18 or wireless wall station 20. Briefly, the wireless transmitter 18, wireless wall station 20, and operator controller 24 may provide a user with certain functions that he or she can invoke at the universal operator 13. For example, a user may depress a button on the wireless transmitter 18 or wireless wall station 20, causing the access barrier, such as gate 14′ to move between an open and a closed position.

Further, a motor 32 is also coupled to the operator controller 24. The motor 32 generally comprises an electric motor that operates on AC electrical power. However, it is contemplated that a DC motor may be used if the universal operator 13 is so configured. The motor 32 is connected to the access barrier, such as a gate 14′, via linkage 36. Although the universal operator 13 and linkage 16 are configured for use with a gate 14′, other movable access barriers such as curtains, gates, awnings, and windows could also be associated therewith. Another component coupled to the operator controller 24, is a mains power source 34. Mains power 34 is defined as standard AC electrical power that is generally available on public commercial power lines, such as 120VAC, at 60 Hz for example. While the system 10 is generally used with mains power 34, it is contemplated that the system 10 may be adapted for use with non-standard line power using known techniques.

An operator port 36 is also coupled to the operator receiver 28, which allows the data monitor 22 to communicate with the operator receiver 28. Specifically, the operator port 36 may comprise a 2-wire serial interface, comprising an RJ-45 port, however other communication interfaces may be utilized. The operator port 36 allows a communication link 23 to be removably connected to the data monitor 22 and the universal operator 13, allowing information to be transferred between the data monitor 22 and operator receiver 28. The communications link 23 typically is comprised of an 8-wire RJ-45 cable with suitable connectors to allow for attachment between the data monitor 22 and the operator port 36 of the operator receiver 28. It should also be appreciated that the operator port 36 may be comprised of a parallel interface or any other suitable communication interface, utilizing any suitable protocol or medium. For example, a wireless interface may be utilized between the data monitor 22 and the operator receiver 28 if the necessary hardware is provided.

Once the monitor port 38 of the data monitor 22 is coupled to the operator port 36 of the operator receiver 28 via the communications link 23, the selected transmitter identification codes can then be transferred to the operator receiver 28 and stored in the receiver memory module 26. As a result, those wireless transmitters 18 or wall stations 20, whose identification codes have been transferred to and stored at the operator receiver 28 are now able to actuate the universal operator 13, so as to move the gate 14′, or other access barrier between open and closed positions. Alternatively, once the data monitor 22 and the operator receiver 28 of the universal operator 13 are connected, the identification codes may be transmitted from the operator receiver 28 to the data monitor 22, as will be discussed.

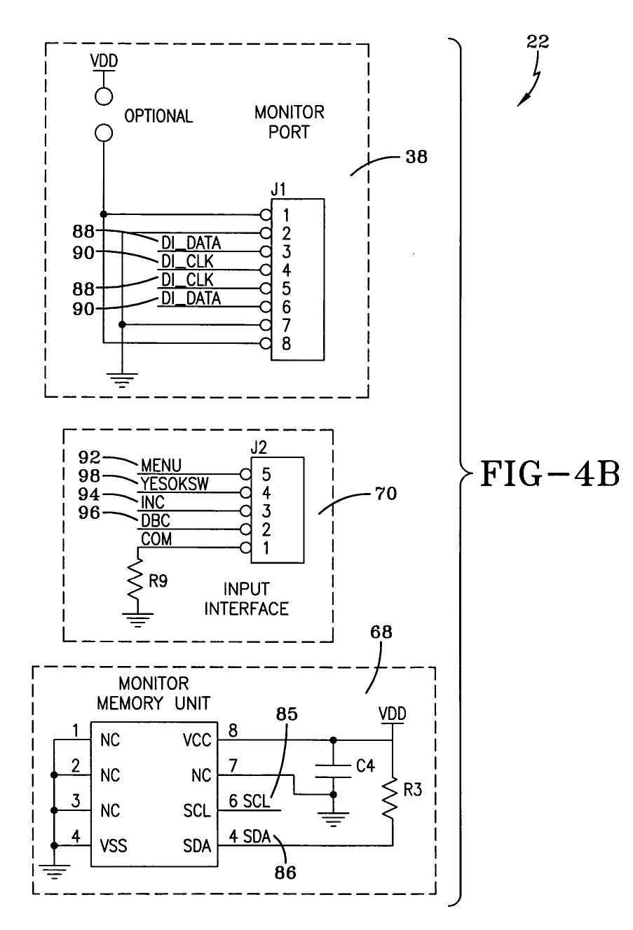

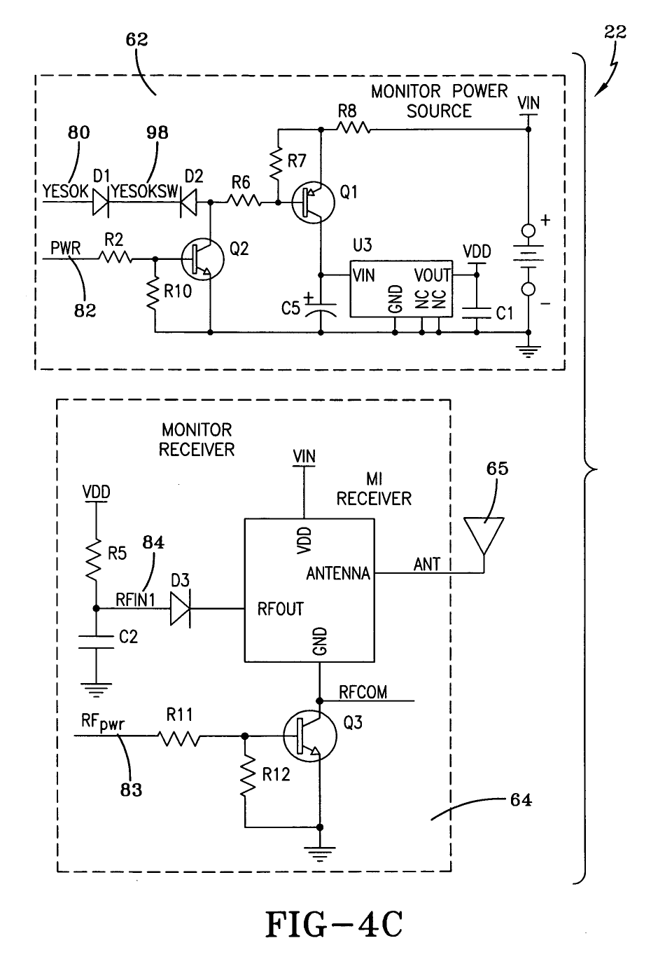

FIG. 3 shows the data monitor 22 comprising a monitor port 38, a monitor controller 60, a monitor power source 62, a monitor receiver 64, a monitor antenna 65, a display 66, a monitor memory unit 68, and an input interface 70. The monitor controller 60 is a logic control that may be implemented using a general purpose, or application specific semiconductor based microprocessor/microcontroller that provides the necessary hardware, and software to carry out the desired functions. Coupled to the monitor controller 60, is a monitor power source 62, which serves to power the controller 60. It should be appreciated that the monitor power source 62 may comprise any suitable portable power source, such as a 9V DC battery. The data monitor 22 also contains a monitor receiver 64 and monitor antenna 65 that are coupled to the monitor controller 60. The receiver 64 and antenna 65 collectively allow the monitor controller 60 to detect a unique identification code generated by a wireless transmitter 18 or wall station 20 and transmitted to the data monitor 22 during the learning process. To allow a user of the data monitor 22 to view various identification data relating to a learned transmitter 18 or wall station 20 a display 66 is coupled to the monitor controller 60. The display 66 may comprise a 2 line, 16 character liquid crystal display (LCD) type screen, however any suitable display may be utilized with the data monitor 22, including a light emitting diode (LED) screen. Yet a further component coupled to the monitor controller 60 is a monitor memory unit 68. The memory unit 68 comprises any suitable type of non-volatile memory, including but not limited to nonvolatile flash memory, or electrically erasable programmable read only memory (EEPROM). It should be appreciated that the memory used with the data monitor 22 may be of such capacity as to allow a user to store 512 transmitter identification codes, however the memory unit's 68 capacity may comprise any capacity. In order to allow a user to interact and/or manipulate stored transmitter identification codes, an input interface 70 is coupled to the monitor controller 60. Typically, the input interface comprises a set of 4 push buttons 72-78, each of which allow the user to interact with the data monitor 22 as shown in FIG. 3. A “MENU/NO” button 72 allows the user to step through the various options provided by the monitor 22. An “ON/YES” button 74 allows the user to initiate the activation of a specific option after an option has been selected using the “MENU/NO” button 72. Further, the input interface 70 includes a “Previous” button 76 and “Next” button 78 both of which allow the user to incrementally scroll through a list of data that cannot be presented completely on the display 60. For example, if a user desires to scroll through the list of transmitter identification codes stored in the monitor memory unit 68, he or she can depress the “Previous” 76 or “Next” 78 buttons to move through the data. Although a push button system may comprise the input interface 70, any other suitable interface may be utilized to interact with the data monitor 22, such as a keyboard, a touchpad, or a joystick.

The monitor port 38 is also coupled to the monitor controller 60 to allow the data monitor 22 to communicate with the universal operator 13. The monitor port 38 comprises a serial interface, such as a 2-wire serial interface using an RJ-45 port. It should be appreciated that the monitor may act as the “master” device that initiates and controls the transfer of data with the operator receiver 28 serving as the “slave” device.

FIGS. 4A-C show an exemplary circuit for representing the data monitor 22 of the present system 10. The circuit comprises the monitor controller 60, the monitor power source 62, the monitor receiver 64, the monitor antenna 65, the display 66, the monitor memory unit 68, the monitor port 38, and the input interface 70.

The monitor controller 60 is comprised of a microprocessor as discussed with respect to FIG. 3. The monitor controller 60 is powered by a monitor power source 62, which comprises dry-cell batteries and associated activation circuitry. The power source 62 is coupled to the monitor controller 60, via connection lines YESOK 80 and PWR 82. Also coupled to the monitor controller 60, via connections RFPWR 83 and RFINI 84 is the monitor receiver 64, with connected monitor antenna 65. The monitor receiver 64 and antenna 65 allows the data monitor 22 to wirelessly receive and learn the identification codes associated with a plurality of wireless transmitters 18 and wireless wall stations 20. A display 66 is also coupled to the monitor controller 60, which allows the learned identification codes to be displayed. The display shown in FIG. 4A comprises a 2 line, 16 character LCD display, however any type of suitable display may be utilized. In order to store the identification information that is learned from a transmitter 18, or wall station 20, the monitor memory unit 68 is coupled to the monitor controller 60 via connections SCL 85 and SDA 86. The monitor memory unit 68 comprises a storage capacity sufficient to store 512 identification codes, but may be configured to comprise any desired memory capacity. Yet another component coupled to the monitor controller 60 is the monitor port 38. The monitor port 38 comprises a serial interface, which may utilize an RJ-45 port to establish the communications link between the data monitor 22 and the operator receiver 28. The monitor port 38, allows the data monitor 22 to transfer stored transmitter identification codes to other devices, including other operator receivers 28 that are compatible with the data monitor 22. The monitor port 38 is coupled to the monitor controller 60 via connection lines which include D1 DATA 88, and D1 CLK 90. Finally, the input interface 70 comprises a 4-button switch set, as discussed with respect to FIG. 3 that are coupled to the monitor controller 60 by connection lines that include: MENU 92, INC 94, and DEC 96. The input interface 70 is also coupled to the power source 62 via lines YESOKSW 98.

The following discussion is directed to FIGS. 2 and 3 and the general operation of the data monitor 22, when used to receive, store, manipulate, and transfer identification data for a plurality of wireless transmitters 18 and wireless wall stations 20. Initially, a user desiring to learn transmitter identification codes to a data monitor 22 enables the data monitor 22 by selecting the appropriate option using the display 66 and the input interface 72. Once the monitor 22 is enabled, the monitor receiver 64 and monitor antenna 65 are able to detect the presence of any transmitter identification codes that are presently being learned with the data monitor 22. Once the data monitor 22 learns the identification code data for one or more wireless transmitters 18 or wireless wall stations 20, each identification code is stored in the monitor memory unit 68. The user may then be presented with a number of other options via the display 66 with respect to the stored identification code data, including but not limited to: deleting a transmitter identification code or codes, determining the amount of free memory remaining in the monitor memory unit 68, incrementing through the list of stored identification codes, decrementing through the list of stored identification codes, selecting specific identification codes for transfer from an operator receiver 28 to a data monitor 22, selecting specific identification code data for transfer to an operator receiver 28, and canceling a selected option.

Should the user desire to transfer a selected group of transmitter identification codes to an operator receiver 28, the user first connects the communication link 23 to the operator port 36 of the operator receiver 28, and to the monitor port 38 of the data monitor 22. Once the communications link 23 is connected, and the appropriate option is selected using the display 66 and the user interface 70, the transmitter identification codes are transmitted from the data monitor 22 to the receiver memory module 26 of the operator receiver 28. The wireless transmitters 18 and wall stations 20 corresponding to the identification data stored in the receiver memory module 26 are now able to actuate the universal operator 13, so as to move the access gate 14′, or other barrier between open and closed positions.

In addition to transferring identification data from the data monitor 22 to one or more compatible operator receivers 28, as discussed previously, a user may alternatively transfer stored transmitter identification codes from an operator receiver 28 to the data monitor 22. Once stored in the data monitor 22, the transmitter identification codes can be subsequently transferred to any number of other operator receivers 28. As a result, each individual transmitter 18 or wall station 20 does not need to be separately learned to each and every receiver operator 28 that the user requires the transmitters/stations 18,20 to actuate. Thus, the time, effort, and inconvenience required to enable a group of wireless transmitters 18, or wireless wall stations 20 with one or more operator receivers 28 is substantially reduced.

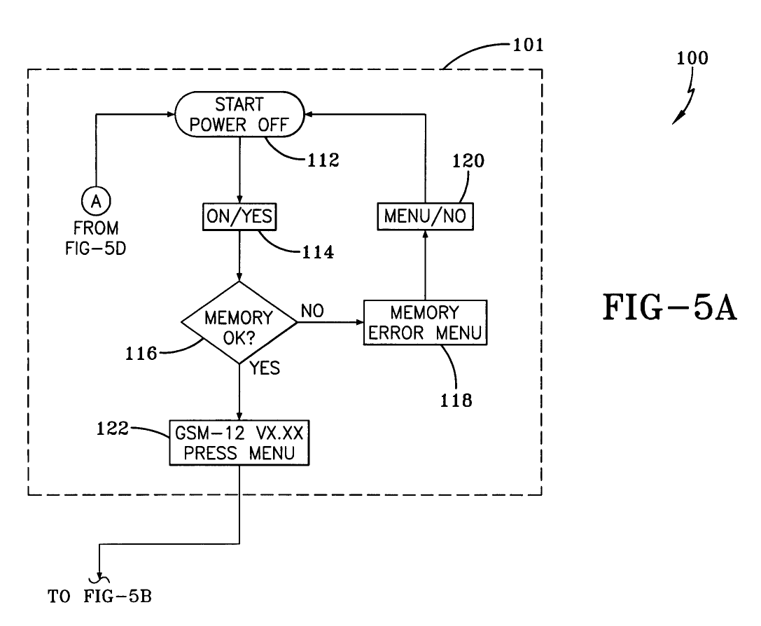

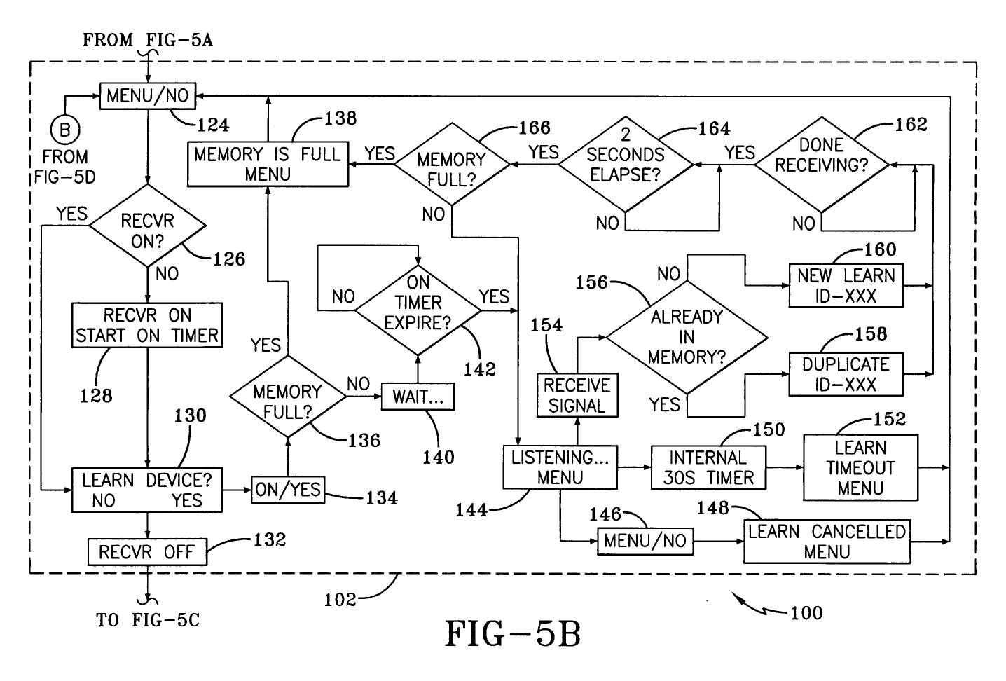

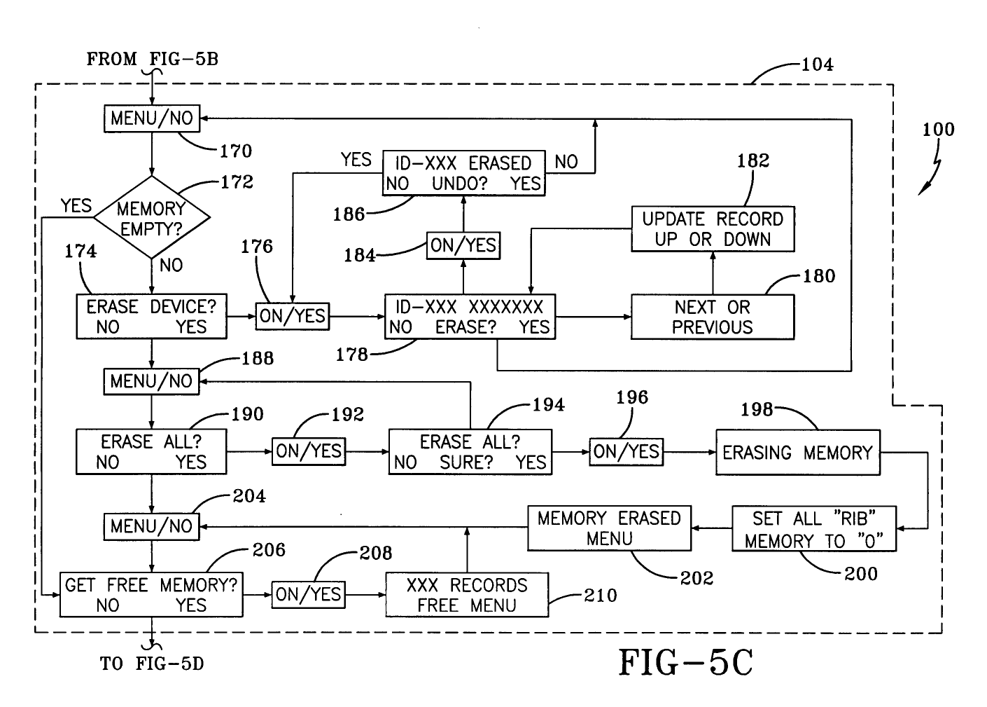

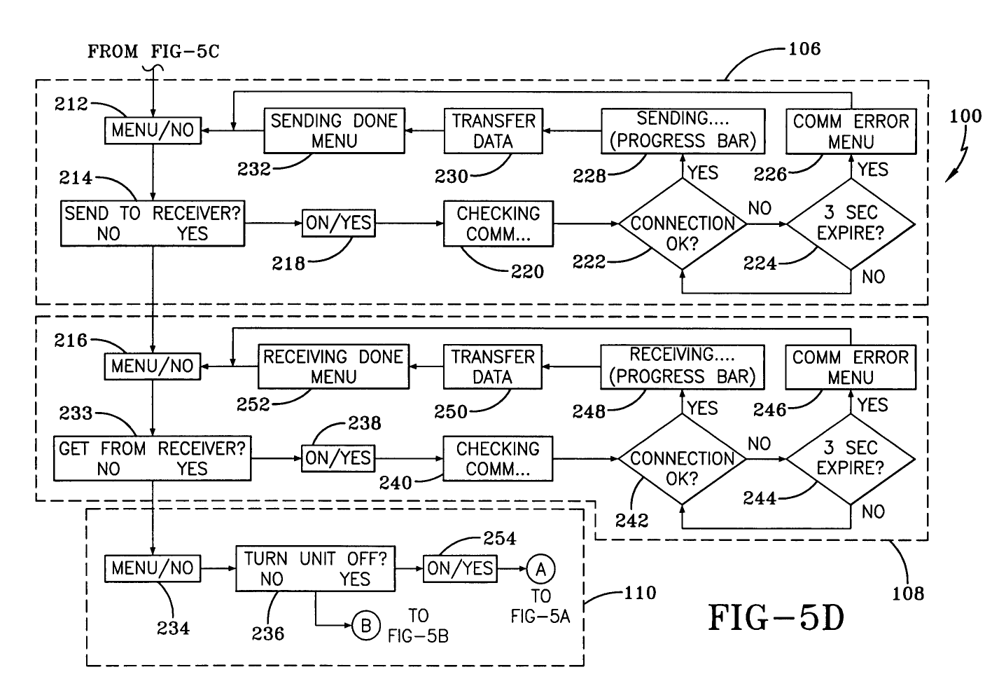

To enable a user to interact with the data monitor 22, the data monitor 22 provides a set of operational steps and/or menus generally indicated by the numeral 100, which are shown in FIGS. 5A-D. The operational steps 100, for clarity purposes have been separated into several functional blocks to delineate one block's general function from that of another block. Specifically, the functional blocks of the data monitor 22 include the following: initialization of the data monitor (i.e. turn “on”) 101, learning of transmitter identification codes 102, deletion of stored transmitter identification codes 104, transfer of identification codes to a universal operator 106, transfer of transmitter identification codes from universal operator to data monitor 108, and deactivate data monitor or turn “off” 110. To enable a user to carry out the operational functions 101-110 shown, the user is prompted with menu options, or options that he or she may select allowing the user to navigate the hierarchy of the operational steps 100, which will be discussed in the following.

The operational steps or process 100 begins at the initialization functional block 101 where the data monitor 22 is in the “off” state as indicated by step 112. To initiate the operation of the data monitor 22, the user depresses the “ON/YES” button 74 as indicated in step 114. Next, at step 116, the monitor memory unit 68 is analyzed to determine if the memory unit 68 is functional. If a memory error is detected then the process moves to step 118, where the user is prompted by a “Memory Error” message via the display 66. When the user acknowledges the error by depressing the “MENU/NO” button 72 on the data monitor 22, as indicated at step 120, the process returns to step 112, where the data monitor 22 is deactivated, and turned “off.” However, if at step 116 the monitor memory unit 68 is determined to be functional, then the process moves to step 122 where the user is greeted with a software identification message, such as “GSM-12 VX.XX,” along with a message to depress the “MENU/NO” button 72 to proceed to a desired option. It should be appreciated that any type of message may be presented to the user at step 122. Once at step 122, the user may depress the “MENU/NO” button 72 the required number of times to proceed directly to a specific option. However, the following discussion will be directed toward proceeding through each option as if each option was sequentially invoked by the user.

If the user depresses the “MENU/NO” button 72 once as indicated at step 124, the process moves to the transmitter learning function group 102 portion of the process 100. Here, the monitor receiver 64 is checked at step 126 to determine whether the receiver 64 is “on” or “off.” If the monitor receiver 64 is not turned “on,” the process 100 moves to step 128, where the receiver 64 is activated for a predetermined period, typically 30 seconds, but may be of any duration. After the receiver 64 is activated, the user is presented with a “Learn Device?” option via the display 66, whereby the user may learn the identification codes of a wireless transmitter 18 or wall station 20, as indicated at step 130. However, if the monitor receiver 64 was turned “on” from a prior operation, the process proceeds directly from step 126 to the “Learn Device?” option at step 130. If the user does not wish to learn the identification code for a wireless transmitter 18 or wall station 20, then the user may select the “MENU/NO” button 72, and the monitor receiver 64 is turned “off” as shown in step 132. But, if the user does desire to learn a wireless transmitter's identification code, then the user may depress the “ON/YES” button 74 as indicated at step 134, causing the process to move to step 136 where the monitor 22 determines if the monitor memory unit 68 has available code storage capacity. If the memory unit 68 is filled, then the process proceeds to step 138 where the user is presented with a “Memory is Full” message on the display 60, whereby the process returns to step 124 upon the user depressing the “MENU/NO” button 72. If the monitor memory unit 68 is not filled, then the process moves to step 140 where the user is given a “wait . . . ” message via the display 66, while the monitor 22 determines whether the timer activated at step 128 has expired. If the timer has not expired the process continues to remain at step 142, while the “wait . . . ” message is also shown on the display 66, until the timer has expired. When the timer has expired, the “wait” message is cleared from the display 66 and the process moves to step 144, where a “Listening . . . ” message is presented to the user via the display 66. If the user desires to cancel the learning function 102 at this point, he or she may depress the “MENU/NO” button 72 as indicated at step 146. Once the “MENU/NO” button 72 is depressed, the process moves to step 148, where a “Learn Cancelled” message is presented via the display 66. If the user depresses the “MENU/NO” button 72 again the user is returned to step 130 (intermediate steps 124, 126, and 128 are not discussed again for clarity). However, if at step 144 the timer's 30 second period has expired as indicated at step 150, then a “Learn Timeout” message is shown on the display 66 as indicated at step 152, and the process returns to step 130 (intermediate steps 124, 126, and 128 are not discussed again for clarity). However, if the user does not cancel the process at step 146 and the internal timer of the data monitor 22 does not expire at step 150, then the process will proceed to step 154 where the data monitor 22 actively receives the transmitter identification code for the wireless transmitter 18 being learned with the data monitor 22. Once the learned transmitter identification code or data is received, the monitor controller 60 determines at step 156, whether the particular transmitter 18 or wall station 20 has been previously learned with the data monitor 22. If the particular wireless transmitter 18 or wall station 20 has been previously learned with the data monitor 22, then the process moves to step 158, where the user is presented with a message “Duplicate ID-XXXX.” If the transmitter identification code has not been stored in the monitor memory unit 68, the message “New Learn ID-XXX” is shown on the display 66, as indicated at step 160. It should be noted that “ID-XXX” as used above, indicates the learned transmitter identification code associated with the learned transmitter 18 or wall station 20. Somewhat simultaneously with steps 154, 156, 158, and 160 the monitor controller 60 determines whether the identification code transmitted by the wireless transmitter 18 or wall station 20 has been completed, as indicated by step 162. If the data monitor 22 has completed its receipt of a transmitter identification code, then the process pauses for 2 seconds, as indicated at step 164, before moving to step 166, where the monitor memory unit 68 is accessed to determine if free space is available in which to store the new transmitter identification code. If there is free space available in the monitor memory unit 68, then the process moves to step 138 where a “Memory is Full” message is presented to the user via the display 66. If memory space is available, then the process returns back to step 144 where the data monitor 22 resumes detecting transmitted identification codes from other wireless transmitters 18 or wall stations 20 that a user may wish to learn. This process continues until the user cancels the learning function 102 by depressing the “MENU/NO” button 72 at step 146, or until the data monitor 22 times-out after a 30 second time lapse without detecting a transmitter identification code, as indicated at step 150.

Once at step 130, depressing the “MENU/NO” button 72 takes the user to function group 104. Here, several options are presented which allow the user to check the available memory of the monitor memory unit 68, or delete stored transmitter identification codes from the monitor memory unit 68 that have been previously learned to the data monitor 22. In particular, depressing the “MENU/NO” button at step 130 results in the data monitor 22 detecting whether the monitor memory unit 68 has an empty memory or not, as indicated by step 172. If the memory is not empty, then the process moves to step 174, where the user is prompted with an “Erase Device?” option via the display 66. This option allows the user to erase an individual transmitter identification code from the monitor memory unit 68. If the user selects the “Erase Devices” option at step 174 by depressing the “ON/YES” button 74, as indicated at step 176, then the transmitter identification code is shown on the display 66, and the user is given the choice of erasing the displayed code from the monitor memory unit 68 by depressing the “YES/ON” button 74 or the “NO/MENU” button 72, as shown in step 178. The user may also elect to scroll through each stored identification code until the particular identification code to be deleted is found. As indicated at steps 180 and 182 by depressing the “Next” button 78 or “Previous” button 76 on the data monitor 22 causes the display 66 to step through each of the stored identification codes, until the desired identification code is displayed as indicated at step 178. Once a desired transmitter identification code is selected at step 178, the user may depress the “NO/MENU” button 72, as indicated at step 170, thus causing the function 104 to be cancelled without deleting the selected identification code. As a result, the process returns to step 174. However, if at step 178 the user depresses the “YES/ON” button 74 as indicated in step 184, the process continues to step 186 where the selected identification code is erased and an “ID-XXX Erase-Undo?” message is presented. This message indicates that the selected identification code has been erased, but may be undone by depressing the “YES/ON” button is displayed as indicated at step 186. If the user depresses the “YES/ON” button 74, as indicated at step 176, the deletion is undone and the process returns back to step 178, where the user can re-select the desired transmitter identification code to be erased from the monitor memory unit 68. However, if at step 186, the user depresses the “NO/MENU” button 72 as indicated at step 170, the transmitter identification code remains deleted and, the process returns to step 174.

If at step 174, the user of the data monitor 22 depresses the “MENU/NO” button 72, as indicated by step 188, the process moves to step 190, where the user is presented with an “Erase All?” option via the display 66. This allows the user of the data monitor 22 to erase all transmitter identification codes stored in the monitor memory unit 68. If at step 190 the user depresses the “ON/YES” button 74 as shown at step 192, the user is presented with an “Erase All?-Sure?” message at step 194 indicating that the user may review the identification codes he or she intends to erase, if the “MENU/NO” button 72 is depressed as indicated at step 188. However, if the user depresses the “ON/YES” button 74 as indicated at step 196, the process moves to step 198 where the display 66 shows the message “Erasing Memory . . . ” indicating that the data monitor 22 is erasing the memory unit 68 as indicated at step 200. Specifically, the data bits comprising the physical memory storage area of the memory unit 68 are set to “0” or “zeroed” out. Once the monitor memory unit 68 is erased, a message is displayed to the user stating “Memory Erased” and the user is prompted to depress the “MENU/NO” button 72, as indicated at step 204, which takes the user to step 206 of the process.

If at step 202, the user depresses the “MENU/NO” button as indicated at step 204, or the YES button at step 172, the process continues to step 206. At step 206, the user is prompted with a “Get Free Memory?” option, which allows the user to determine how much free memory the monitor memory unit 68 has remaining. If the user depresses the “ON/YES” button 74 as indicated in step 208, the process moves to step 210, where the display 66 of the data monitor 22 presents the user with the number of records or memory blocks that are available to store transmitter identification codes within the monitor memory unit 68. Generally, one record or memory block corresponds to the amount of memory space available to store one transmitter identification code. For example, if 300 records or memory blocks are available, then 300 transmitter identification codes may be stored. Once the number of free memory records are shown on the display 66, the process returns to step 206 once the user depresses the “MENU/NO” button 72 as indicated at step 204.

If at step 206, the user depresses the “MENU/NO” button 72, as indicated at step 212, the process moves to functional block 106, whereby the user may transfer stored transmitter identification codes from the data monitor 22 to an operator receiver 28. At step 214, a “Send To Receiver” option is provided to the user via the display 66. If the user depresses the “MENU/NO” button 72 as indicated at step 214, the process proceeds to step 216. However, if at step 214 the “ON/YES” button 74 is depressed, as indicated by step 218, the process continues to step 220. At step 220, the data monitor 22 shows a “Checking Comm . . . ” message on the display 66. Somewhat simultaneously with step 220, the monitor 22 determines whether a communications connection has been established between the data monitor 22 and the operator receiver 28, as indicated at step 222. Typically a communications connection is established between the data monitor 22 and a barrier operator 12 via communications link 38 as discussed above, with regard to FIGS. 1-3. If the communications connection has not been properly established within 3 seconds as indicated at step 224, the process proceeds to step 226 where the user is prompted with a “Comm Error” message that is presented on the display 66. If at step 226, the user depresses the “MENU/NO” button 72, as indicated at step 212, the process returns to step 214. However, if a communications connection has been properly established at steps 222 and 224, then the process continues to step 228, where a “Sending . . . ” message is presented on the display 66. Somewhat simultaneously, the transmitter identification data stored in the monitor memory unit 68 is transferred to the receiver of the operator receiver 28 where it is stored in the receiver memory module 26, as indicated at step 230. After the identification data has been fully transferred, the process moves to step 232, where the user is prompted with a “Sending Done” message that is shown on the monitor's display 66. If at step 232 the user depresses the “MENU/NO” button 72 the user is returned to step 214.

If at step 214, the user depresses the “MENU/NO” button 72, the process continues to function group 108, where the user may transfer transmitter identification codes from an operator receiver 28 for storage on the data monitor 22. Upon actuation of the “MENU/NO” button at step 216, the process continues to step 233 and the user is prompted by a “Get FRM Receiver” option via the display 66. If at step 233, the “MENU/NO” button 72 is depressed as indicated at step 234, the process continues to step 236. However, if the user depresses the “ON/YES” button 74 as indicated at step 238 the display 66 of the data monitor 22 presents the user with the message “Checking Comm . . . ” as shown at step 240. It should be appreciated that prior to step 238, the user would connect the data monitor 22 with the operator receiver 28, using the communications link 23 as previously discussed. Somewhat simultaneously with step 240, the data monitor 22 determines if the communications connection established between the data monitor 22 and the operator receiver 28 is properly established. If the connection is incorrectly established or not established at all after 3 seconds, then the process continues to step 246 where the user is presented with a “Comm Error” message that is displayed on the data monitor's display 66 and the process returns to step 233 when the user depresses the “MENU/NO” button 72 as indicated at step 216. However, if at steps 242 and 244 the communications connection has been determined to be properly established, the process continues to step 248, where the monitor display 66 prompts the user with a “Receiving . . . ” message. Somewhat simultaneously with step 248, step 250 is commenced, whereby the transmitter identification codes stored within the memory of the operator receiver 28 are transferred to the monitor memory unit 68 of the data monitor 22. Once the data transfer is completed, the user is prompted with a “Receiving Done” message via the display 66, as indicated at step 252. If the user depresses the “MENU/NO” button at step 252, the process returns to step 233.

If the user depresses the “MENU/NO” button 72 at step 233 as shown at step 234, the process moves to the deactivate function group 110, shown by step 236, whereby the “Turn Unit Off?” option is shown on the monitor display 66. If the user does not desire to turn the data monitor 22 “off,” then he or she may depress the “MENU/NO” button 72 indicated by step 124, where the user is taken back to the “Learn Device?” menu option shown at step 130 (intermediate steps 124, 126, and 128 are disregarded for clarity). Should the user desire to turn the data monitor 22 “off” at step 236, he or she may then depress the “ON/YES” button 74 as indicated at step 254, as such, the process returns to step 112, where the data monitor 22 is deactivated or otherwise turned “off.” It should also be appreciated that the data monitor 22 may automatically turn “off” if no input is provided at the input interface 70 after a pre-determined period of time, such as 5 minutes.

It should be appreciated that if the user is at step 122, 130, 174, 190, 206, 214, 233, or 236, they may move to any desired option indicated at steps 122, 130, 174, 190, 206, 214, 233, or 236 by depressing the “MENU/NO” button 72 repeatedly until the desired option is presented on the display 66.

It will, therefore, be appreciated that one advantage of one or more embodiments of the present system is that identification codes associated with a wireless transmitter for a barrier operator can be received, stored, manipulated, and transmitted by a data monitor. Still another advantage of the present system is that a visual display and an input interface are utilized by the data monitor to allow a user to easily select and initiate a desired option. Yet another advantage of the present system is that identification codes associated with a particular wireless transmitter may be transferred from the data monitor to a universal operator. And an additional advantage of the present system is that identification codes associated with a particular wireless transmitter may be transferred from a universal operator to a data monitor.

Although the present invention has been described in considerable detail with reference to certain embodiments, other embodiments are possible. Therefore, the spirit and scope of the appended claims should not be limited to the description of the embodiments contained herein.

What is claimed is:

1. An electronic data acquisition and transmission system for processing transmitter identification codes used with a universal barrier operator, the system comprising:
a monitor controller configured to receive and store transmitter identification codes, wherein selected said transmitter identification codes enable operation of selected barrier operators, and wherein all said transmitter identification codes enable operation of the universal barrier operator; and
an input interface coupled to said monitor controller, said input interface providing functional options to process said transmitter identification codes.

2. The system according to claim 1, wherein said functional options are selected from the group consisting of receiving, storing, manipulating and transmitting.

3. The system according to claim 2, further comprising:
a display coupled to said monitor controller, said display configured to show said at least one functional option provided by said monitor controller.

4. The system according to claim 3, further comprising:
a monitor port coupled to said monitor controller, said monitor port configured to allow functional options of acquisition, storing and transmitting of said transmitter identification codes between said universal operator and said monitor controller.

5. The system according to claim 4, wherein said monitor port comprises a serial interface.

6. The system according to claim 4, wherein said input interface comprises one or more push buttons.

7. The system according to claim 1, further comprising:
a monitor receiver having an antenna for receiving said transmitter identification codes transmitted from a transmitter, said monitor receiver coupled to said monitor controller.

8. The system according to claim 7, further comprising:
a monitor memory unit coupled to said monitor controller, said monitor memory unit storing said transmitter identification codes received by said monitor receiver.

9. A method of learning one or more transmitter identification codes that enable operation of selected barrier operators, wherein all of the transmitter identification codes enable operation of a universal operator, the method comprising:
providing a data monitor having a monitor controller connected to an input interface;
providing at least one transmitter having at least one identification code that enables operation of a selected barrier operator, and where all said identification codes enable operation of a universal barrier operator;
enabling a learn mode of said monitor controller through said input interface; and
transmitting said at least one identification code from said at least one transmitter for receipt by said data monitor during said learn mode.

10. The method according to claim 9 comprising:
providing a monitor receiver having a monitor antenna coupled to said monitor controller and a monitor memory unit coupled to said monitor controller;
receiving said identification code by said monitor receiver; and
storing said identification code in said monitor memory unit.

11. The method according to claim 10, further comprising:
determining whether said monitor memory unit has available storage space prior to said enabling step.

12. The method according to claim 11, further comprising:
checking whether said identification code received at said receiving step matches an identification code previously stored in said monitor memory unit.

13. The method according to claim 12, further comprising:
displaying a message on said display indicating whether said identification code received at said receiving step matches an identification code previously stored in said monitor memory unit.

14. The method according to claim 13 further comprising:
ending said enabling step at said displaying step, if said identification code received at said receiving step matches an identification code stored in said monitor memory unit.

15. The method according to claim 13 further comprising:
ending said enabling step if at said receiving step said data monitor fails to receive an identification code within a predetermined period of time.

16. The method according to claim 15 further comprising:
analyzing said monitor memory unit after said storing step to determine if the monitor memory unit has been filled to capacity; and
displaying a message on said display indicating that said monitor memory unit is filled if appropriate.

17. A method of exchanging one or more transmitter identification codes that enable operation of selected barrier operators to a universal barrier operator, comprising:
providing a data monitor having a monitor controller connected to an input interface;
providing a monitor memory unit connected to said monitor controller, said monitor memory unit adapted to store at least one transmitter identification code that enables operation of at least one selected barrier operator;
providing a universal barrier operator having a universal barrier operator controller and a universal operator memory module adapted to store all said transmitter identification codes which enable operation of said universal barrier operator;
coupling said data monitor to a universal barrier operator;
enabling a transfer mode of said monitor controller through said input interface; and
exchanging said transmitter identification codes between said monitor memory unit and said universal operator memory module during said transfer mode.

18. The method according to claim 17 comprising:
presenting an option on said input interface to enable said data monitor to transfer said stored identification codes to said universal operator memory module; and
transferring and storing said stored identification codes from said data monitor to said universal operator.

19. The method according to claim 18, further comprising:
providing a display connected to said monitor controller; and
displaying a message on said display indicating whether the transfer of said identification code was successful.

20. The method according to claim 18, wherein said input interface comprises one or more push buttons.

21. The method according to claim 18, wherein said coupling step comprises coupling said data monitor and said universal operator together with a communications link.

22. The method according to claim 19, further comprising:
displaying a message on said display indicating whether the transfer of said at least one transmitter identification code was completed.

23. The method according to claim 17 comprising:
presenting an option on said interface to enable said data monitor to cause said universal operator to transfer said at least one stored identification code to said monitor memory unit; and
transferring and storing said at least one transmitter identification code from said universal operator to said data monitor.

24. The method according to claim 23, further comprising:
providing a display connected to said monitor controller; and
displaying a message on said display indicating that said at least one identification code has been transferred to said data monitor.

25. The method according to claim 24, further comprising:
checking the validity of said coupling step.
